(19) United States
(12) Patent Application Publication
(10) Pub. No.: US 2018/0146222 A1
(43) Pub. Date: May 24, 2018

(54) SYSTEMS AND METHODS FOR DEMULTIPLEXING AND MULTIPLEXING MULTIMEDIA STREAMS THAT HAVE SPURIOUS ELEMENTARY STREAMS

(71) Applicant: Akamai Technologies, Inc., Cambridge, MA (US)

(72) Inventor: Kourosh Soroushian, San Diego, CA (US)

(73) Assignee: Akamai Technologies, Inc., Cambridge, MA (US)

(21) Appl. No.: 15/360,170

(22) Filed: Nov. 23, 2016

(51) Int. Cl. H04N 21/2368; H04N 21/434; H04N 21/8547

(52) U.S. Cl. CPC H04N 21/2368; H04N 21/8547; H04N 21/4341

(57) ABSTRACT

Described herein are systems, methods and apparatus for demultiplexing and multiplexing multimedia streams where one or more of the underlying elementary streams appears intermittently, that is, one or more particular elementary streams are “spurious”. Typically, a multiplexed multimedia stream contains elementary streams for video, audio and ancillary data. A transcoding process typically involves demultiplexing into elementary streams, transcoding, and then multiplexing the elementary streams back into a multiplexed stream. Bu if one of the elementary streams is not present for a time period, then a multiplexer that expects a continuous stream of data of each elementary stream type may fail or excessively buffer the elementary streams that are present. Without limitation, the teachings presented here provide solutions to the problems of handling spuriously appearing sources in a transcoding solution.

This patent document contains material which is subject to copyright protection. The copyright owner has no objection to the facsimile reproduction by anyone of the patent document or the patent disclosure, as it appears in Patent and Trademark Office patent files or records, but otherwise reserves all copyright rights whatsoever.

### BACKGROUND

### Technical Field

This application generally relates to distributed data processing systems and to the demultiplexing and multiplexing of multimedia streams, particularly in the context of a transcoding system that processes video along with audio and ancillary data elementary streams.

### Brief Description of the Related Art

Transcoding of multimedia streams supports the distribution of content to a wide variety of devices. For example, content providers often will need multiple versions of a given movie title at different screen sizes, bit rates, quality levels and client player formats. This may be necessary to support a wide ecosystem of client devices, as well as adaptive bitrate streaming technologies, which require multiple renditions at various bitrates. Furthermore, over time a content provider may want to change formats, for example by updating the encoding (e.g., to take advantage of newer codecs that compress content more efficiently). They may also need to change the container format to accommodate new client environments, a process often referred to as trans-multiplexing, or transmuxing for short. Failing to provide certain bit rates or poor encoding practices will likely reduce the quality of the stream. But, generating so many different versions of content, as well as converting from one to another and storing them, is a time-consuming and costly process that is difficult to manage.

Generally speaking, a given multimedia file is built from data in several different formats. For example, the audio and video data are each encoded using appropriate codecs, which are algorithms that encode and compress that data. Example codecs include H.264, VP6, AAC, MP3, etc. There is also a container or package format that functions as a wrapper and describes the data elements (in particular, the elementary stream access units) and metadata of the multimedia file, so that a client application (the multimedia player) knows how to play it. Example container formats include Flash, Silverlight, MP4, PIFF, and MPEG-TS.

In a distributed transcoding system, incoming sources (such as video, audio, and ancillary data elementary streams) may be demultiplexed and converted by different encoding resources. As mentioned above, the conversion process often involves the decoding and re-encoding of those streams with different parameters, making them more suitable for decoding on a variety of device and network conditions. When transcoding, it is possible that some of the input sources may be re-multiplexed directly into the outgoing stream, without any conversion (e.g., the video may be converted, but the audio passed through and not converted). Known distributed transcoding systems, as well as multimedia streaming systems for delivering transcoded streams, are described in U.S. Pat. Nos. 9,485,456 and 9,432,704 and US Patent Application Publication Nos. 2013-0117418 A1 and 2012-0265853-A1, the teachings of all of which are hereby incorporated by reference in their entireties for all purposes.

In general, input source timestamps are attached to each demultiplexed elementary stream access unit (AU). An access unit is sometimes referred to as an elementary stream ‘frame’ or ‘packet’, both in the art and in this document. The timestamps, which may be decode timestamps or presentation timestamps for example, are maintained throughout the encoding and multiplexing process. If streams undergo a frame-rate conversion process, the timestamps are still maintained even while the access units are duplicated, dropped, or resampled.

In order to create an output multiplexed stream from demultiplexed elementary streams that may be processed by separate encoders, a multiplexer may expect a continuous stream of video, audio, and ancillary data access units. This is so because a multiplexer may be required to multiplex access units with close proximity in timestamp, in order to avoid excessive buffering at the downstream decoding device(s), such as e.g. a multimedia player. A solution is to have the multiplexer wait for at least one access unit from each outgoing elementary stream, and once received, the multiplexer can sort those access units in the order of increasing timestamps and subsequently multiplex them together using a desired container format, to create a multiplexed stream. In this situation, however, any elementary stream(s) that are not available contiguously in time can cause excessive buffering and ultimately failure at the multiplexer. In the worst case, an elementary stream may be absent for long durations of a presentation, which can force an unacceptable pause in the multiplexed output stream for live scenarios, as well as unattainable buffering requirements while the multiplexed is waiting for an access unit from the spurious source elementary stream.

Hence, there is a need for improved transcoding systems that can properly and efficiently accommodate spuriously appearing source elementary streams. The teachings herein address these needs and also provide other benefits and improvements that will become apparent in view of this disclosure.

Note that for shorthand, the term ‘multiplexer’ is sometimes referred to as a ‘muxer’ and a ‘demultiplexer’ is sometimes referred to as a ‘demuxer’, without change in meaning. Likewise, ‘multiplexing’ is sometimes referred to as ‘muxing’, while ‘demultiplexing’ is sometimes referred to as demuxing′. Likewise, ‘multiplexed’ is sometimes referred to as ‘muxed, while ‘demultiplexed’ is sometimes referred to as demuxed′. These apply generally in the in the field of this invention and in this document.

### SUMMARY

Described herein are systems, methods and apparatus for demultiplexing and then multiplexing (also referred to as re-multiplexing) multimedia streams where one or more of the underlying elementary streams appears only intermittently, that is, the elementary stream is “spurious”. Typically, a multimedia stream contains elementary streams for video, audio and ancillary data. An ancillary data stream is typically used for carrying ID3 tags and/or other information such as a program insertion cueing message (CUEI) or the Nielsen content identifier (NMR1). As mentioned above, oftentimes an ancillary data stream or an audio stream will appear only occasionally in the multimedia stream. This means that that at for some portions of the presentation, the multimedia stream may contain video and audio data, but the ancillary data may not be present. (But, any type of elementary stream could appear spuriously, not just ancillary data.) In this situation, a multiplexer expecting a continuous stream of data of each type may fail, or have to apply excessive buffering to the elementary streams that are present. At a minimum, the muxer may not be able to determine the cause of the absence of the missing elementary stream. The cause may vary, after all; it might be that a particular source is spurious, or might be that there are unequal processing delays across elementary streams (e.g., the video may take longer to be handled by intermediate elements such as transcoders, relative to audio, depending on workloads and other factors). This phenomenon is exacerbated when intermediate elements operate at different speeds or are distributed across different locations and thus become subject to network variables, such as congestion.

The teachings presented here provide solutions to the problem of how to handle spuriously appearing sources, particularly in a distributed transcoding solution. The teachings hereof include, among other things, inserting markers in the flow of elementary stream access units at certain times, as dictated by certain events. These markers provide a signal to the muxer to proceed with multiplexing the available access units from other source elementary streams that are present.

According to the teachings hereof, a transcoding system can comprise a demultiplexer, a set of intermediate processes (such as transcoder processes) for processing the demuxed elementary streams, and a multiplexer for muxing the processed elementary streams back into a multimedia stream. A common use case is to demux a multimedia stream from the container format, transcode the video and/or audio, pass through ancillary data, and then mux the resulting elementary streams into the original container format or another container format.

Preferably, the system employs markers, which are preferably special access units, to inform the muxer about the status of a spuriously appearing data source. The demuxer can examine the incoming elementary streams and, when it detects that one elementary stream is “too far” behind the others, it sends a special marker access unit downstream to the muxer. Preferably the demuxer determines that a given elementary stream is “too far” behind when its timestamps lag behind by the timestamps of other elementary streams by some predetermined threshold value. (Timestamps are preferably decode timestamps but are not limited to such. The presentation timestamps could be used, for example.) The marker may travel via the transcoders, or via pass-through elements, or directly. The muxer waits for access units from every elementary stream. When the muxer receives a marker access unit for an elementary stream, it can consider consider that elementary stream as having been received, which signals it to proceed with muxing the access units from the other elementary streams. The marker access unit is preferably discarded by muxer and not incorporated into the muxed output.

With this approach, the muxer can effectively distinguish between a gap in source elementary stream data (indicated by the marker access unit), mere congestion in the transcoding system (indicated when is no marker access unit but time threshold for failure has not been met), or failure (indicated if no marker access unit arrives and a failure time threshold has been met). Any of these could lead to unequal arrival times at the muxer for the elementary streams. Moreover, with this technique the receive buffer at the muxer can be bounded. This means that, if desired, the receive buffer can be based on the size of the predetermined threshold value for sending the marker access units, and preferably sized to be no larger than the predetermined threshold value.

By way of further illustration, in one embodiment, a method is provided to be performed in a transcoding system that comprises a demultiplexer process, a plurality of transcoder processes that include a first and second transcoder processes, and a multiplexer process, each process hosted in at least one of one or more computers in the transcoding system. The method involves, with the demultiplexer process, receiving a multimedia stream that includes a plurality of multiplexed elementary streams, the plurality of elementary streams each having a type and each having a plurality of access units of that type, including a first elementary stream of a first type and a second elementary stream of a second type, wherein the first and the second types are different from one another and the first and second types are each selected from the group of types consisting of: video, audio, ancillary data. The method further involves demultiplexing a first portion of the multimedia stream to obtain a first access unit that has a first type and a second access unit that has a second type, determining a first timestamp for the first access unit and a second timestamp for the second access unit, and setting the first timestamp as a maximum timestamp associated with the first type and the second timestamp as a maximum timestamp associated with the second type, wherein the maximum timestamp associated with the first type and the maximum timestamp associated with the second type are each stored in memory. The demultiplexer then sends the first access unit to a first transcoder process, and the second access unit to a second transcoder process or the multiplexer process, as the case may be. The demultiplexer then demuxes a second portion of the multimedia stream to obtain a third access unit that has the first type, and determines a third timestamp for the third access unit. It then sends the third access unit to the first transcoding process, and sets the third timestamp as the maximum timestamp associated with the first type. The demultiplexer compares the maximum timestamp associated with the first type, which is equal to the third timestamp, to the maximum timestamp associated with the second type, which is equal to the second timestamp. Based at least in part on upon a determination that the maximum timestamp associated with the first type, which is equal to the third timestamp, exceeds the maximum timestamp associated with the second type, which is equal to the second timestamp, by a predetermined threshold value, the demultiplexer does the following: generating and sending a marker access unit to at least one of: (i) the multiplexer process, and (ii) the second transcoder process, for subsequent transmission to the multiplexer process.

Further, the method can involve, based at least in part on upon the determination that the third timestamp exceeds the stored second timestamp by a predetermined value: the demultiplexer setting the third timestamp as the maximum timestamp associated with the second type.

Further, the method can involve, with the multiplexer process, monitoring a plurality of buffers associated with the multiplexer, the plurality of buffers including at least one buffer associated with each of the plurality of elementary streams, such that the at least one buffer for a given elementary stream receives access units of a type corresponding to the given elementary stream, wherein the plurality of buffers includes a first buffer associated with the first type and a second buffer associated with the second type. The multiplexer can then monitor the plurality of buffers to determine when the multiplexer process has received at least one access unit for each of the plurality of elementary streams, and when the multiplexer process has received at least one access unit for each of plurality of elementary streams (wherein said determination comprises the multiplexer treating the marker access unit as the at least one access unit of the second type), the multiplexer can proceed by discarding the marker access unit and muxing the other access units.

In some implementations, the marker access unit includes a code that enables the multiplexer to distinguish the marker access unit from access units of the video stream type, audio stream type, and ancillary data stream type. The plurality of transcoding processes can be hosted in a plurality of distributed computers distinct from one another and from the host of the multiplexer process and the host of the demultiplexer process, to form a distributed transcoding system. In some cases, the plurality of elementary streams can be three or more elementary streams, and the first elementary stream can be any of a video stream and an audio stream, the second elementary stream can be any of an audio stream and an ancillary data stream, and the third elementary stream can be any of a video stream and an audio stream. Or, there can be more than three elementary streams, with one of the elementary streams being of a video type, and each of the remaining elementary streams being any of: audio type and ancillary data type.

In another embodiment, there is a method that is performed by a transcoding system that comprises a demultiplexer process, a plurality of intermediate processes, and a multiplexer process, each process hosted in one or more computers in the transcoding system. The method can involve, with the demultiplexer process, receiving a multimedia stream comprising a plurality of multiplexed elementary streams each having a plurality of access units, each of the plurality of elementary streams and access units thereof being of a type, the type selected from the group of types consisting of: video, audio, ancillary data. The demultiplexer demuxes the plurality of multiplexed elementary streams to obtain access units for the plurality of elementary streams. It then determines timestamps for each of the obtained access units of the plurality of elementary streams. It maintains a maximum timestamp value, independently, for each of the plurality of elementary streams. It does this by, upon demultiplexing a given access unit of the given elementary stream type from the multimedia stream, updating a maximum timestamp value for a given elementary stream type with the timestamp value extracted from the given access unit. The demultiplexer sends each obtained access unit of a given elementary stream type to any of: the multiplexer, and an intermediate process in the plurality of intermediate processes. It compares the maximum timestamp values maintained for each of the plurality of elementary streams. Upon a determination that the maximum timestamp value for a first elementary stream exceeds the maximum timestamp value for a second elementary stream, at least by a predetermined value, the demultiplexer reacts by generating and sending a marker access unit to any of: (i) the multiplexer process, and (ii) one of the one or more intermediate processes that is of the second elementary stream type. The method further involves, with each of the plurality of intermediate processes, receiving access units of a given elementary stream from the demultiplexer process, and processing said access units to create processed access units of the given elementary stream. (The processing typically comprises (i) transcoding or (ii) passthrough.) The intermediate processes then send processed access units of the given elementary stream to the multiplexer process. The method further can involve, with the multiplexer process, receiving access units from any of: (i) the demultiplexer, and (ii) the plurality of intermediate processes. The multiplexer buffers the received access units in a plurality of buffers. The buffering typically involves buffering access units of a given elementary stream in a buffer corresponding to the given elementary stream. The multiplexer monitors the plurality of buffers to determine when the multiplexer process has received at least one access unit associated with every one of the plurality of elementary streams. In doing this, the multiplexer treats the marker access unit as the access unit associated with the second elementary stream. When this determination is made, the multiplexer discards the marker access unit, and does a multiplexing operation on the other access units.

The method can further involve, upon the demultiplexer process sending the marker access unit, the demultiplexer process updating the maximum timestamp value for the second elementary stream to equal the timestamp value of the first elementary stream.

The marker access unit can include a code that enables the multiplexer to distinguish the marker access unit from access units of the video stream type, audio stream type, and ancillary data stream type.

In many cases, the intermediate processes are hosted in a plurality of distributed computers distinct from one another and from the host of the multiplexer process and the host of the demultiplexer process, to form a distributed transcoding system.

There can be any number of elementary streams. In some cases, there are three such streams with the first elementary stream being a video stream or an audio stream, the second elementary stream being audio stream or an ancillary data stream, and the third elementary stream being any of a video stream or an audio stream. Alternatively, there can be more than three elementary streams, with one of the elementary streams being of a video type, and each of the remaining elementary streams being any of: audio type and ancillary data type.

The subject matter described herein has a wide variety of applications in content delivery and online platform architectures.

As those skilled in the art will recognize, the foregoing description merely refers to examples of the invention. It is not limiting and the teachings hereof may be realized in a variety of systems, methods, apparatus, and non-transitory computer-readable media. It should also be noted that the allocation of functions to particular machines is not limiting, as the functions recited herein may be combined or split amongst different machines in a variety of ways.

### BRIEF DESCRIPTION OF THE DRAWINGS

The invention will be more fully understood from the following detailed description taken in conjunction with the accompanying drawings, in which:

FIG. 1 is a schematic diagram illustrating an embodiment of a transcoding system in accordance with the teachings hereof, and in particular the demultiplexing and multiplexing in a typical distributed transcoding system;

FIG. 2 is a diagram illustrating an embodiment of the logical flow of an algorithm executed by the transcoding system shown in FIG. 1, in accordance with the teachings hereof;

FIG. 3 is a table illustrating an embodiment of steps 214, 216, 218 shown in FIG. 2, in accordance with the teachings hereof;

FIG. 4 is a block diagram illustrating hardware in a host computer system that may be used to implement the teachings hereof;

FIG. 5 is a schematic diagram illustrating one embodiment of a known distributed computer system configured as a content delivery network (CDN); and,

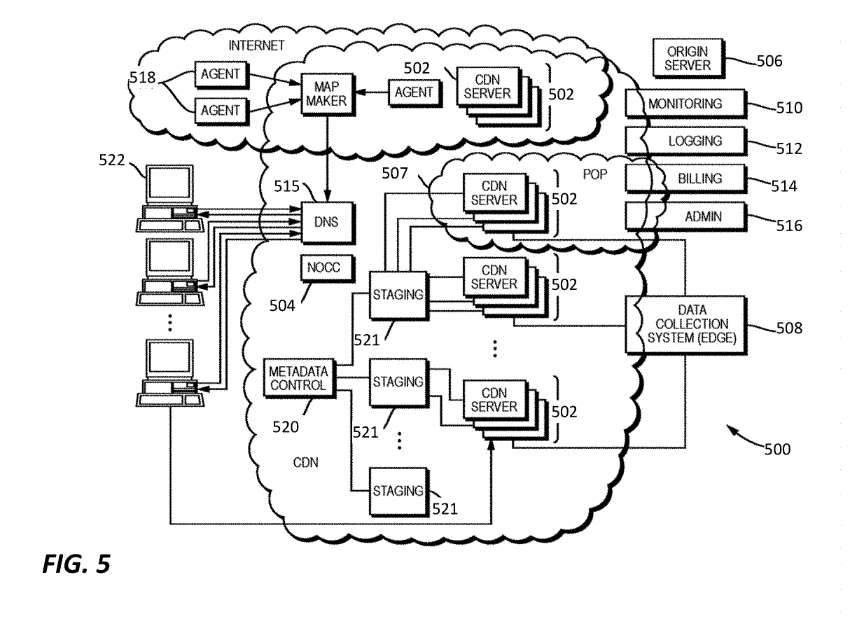

FIG. 6 is a schematic diagram illustrating one embodiment of a machine by which a content delivery server in the system of FIG. 1 can be implemented.

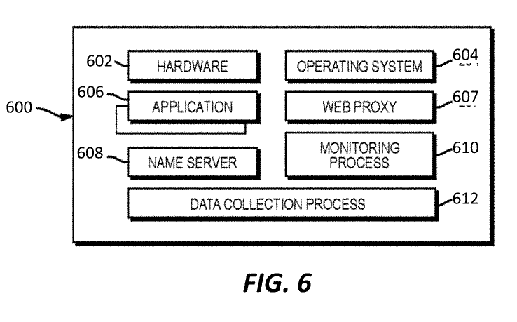

### DETAILED DESCRIPTION

The following description sets forth embodiments of the invention to provide an overall understanding of the principles of the structure, function, manufacture, and use of the methods and apparatus disclosed herein. The systems, methods and apparatus described in this application and illustrated in the accompanying drawings are non-limiting examples; the claims alone define the scope of protection that is sought. The features described or illustrated in connection with one exemplary embodiment may be combined with the features of other embodiments. Such modifications and variations are intended to be included within the scope of the present invention. All patents, patent application publications, other publications, and references cited anywhere in this document are expressly incorporated herein by reference in their entirety, and for all purposes. The term “e.g.” used throughout is used as an abbreviation for the non-limiting phrase “for example.”

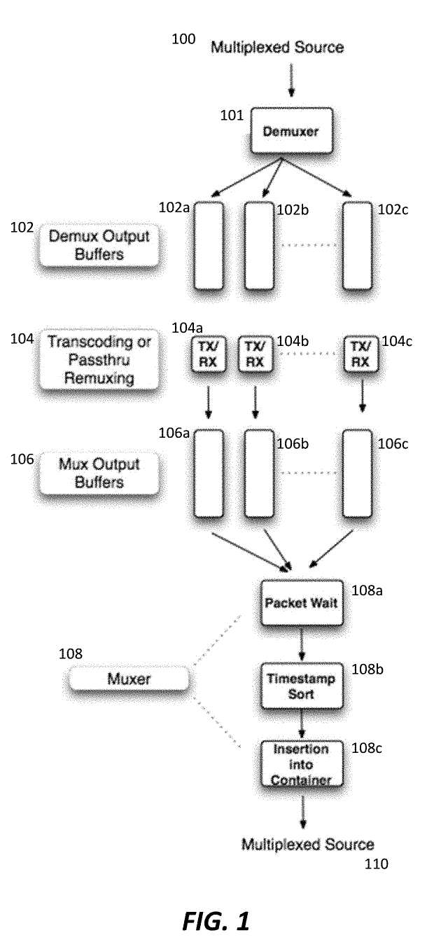

FIG. 1 illustrates one embodiment of a transcoding system 100 according to the teachings hereof. The system 100 has a demultiplexer process (sometimes referred to herein as a demultiplexer or demuxer), several transcoding processes, and a multiplexer process (sometimes referred to herein as a multiplexer or re-muxer). Generally speaking, the system 100 operates to receive a multiplexed source stream, such as a multimedia stream in a container format. The system's job is to perform a user-specified transcoding operation on the multiplexed stream. There are a wide variety of possible purposes for transcoding, as mentioned earlier. The teachings hereof are not limited to any one kind. As already mentioned, a user may desire to change the container format for the multiplexed stream. The user may want to change the bitrate, resolution, frame size, or other encoding parameters of video data in the video elementary stream. Similarly, the user may want to change parameters of the audio encoding. The user may want to trans-rate the video in the video elementary stream to a different frame rate.

Referring to FIG. 1, the incoming source stream 100 is demultiplexed into separate audio, video, and ancillary data streams by the demuxer 101. The demuxer 101 preferably buffers these elementary streams in buffers 102 to account for different speeds of consumption by the transcoders 104. Assume in this case that there is a buffer for each elementary stream, i.e., a buffer for video data 102a, a buffer for audio 102b, and a buffer for the ancillary data 102c. According to the teachings hereof, the demuxer continually analyzes the access units of the elementary streams before sending them to the transcoder resources 104. In general, the demuxer analyzes timestamps (e.g., decode timestamps) of the access units of the elementary streams to determine whether one stream is behind another stream by a predetermined threshold amount. For example, assume that the latest video elementary stream access unit is at decode timestamp of 8 seconds, the latest decode timestamp seen for the ancillary data elementary stream is 1 second, and that the threshold is 6 seconds. Because the ancillary data stream is more than 6 seconds behind the elementary stream that is farthest along (i.e., has the maximum timestamp), the demuxer identifies the lagging elementary stream as a spurious source. To address this, the demuxer generates and inserts a marker access unit into the ancillary data elementary stream.

The demuxer 101 sends elementary stream access units (including any marker access units) through the system for intermediate processing. Here the processing is represented by the transcoding 104. The elementary stream access units of each type are sent to the corresponding transcoding resources 104a-c. Transcoder resources are typically host computers, potentially remote to the demuxer and muxer, that run software to convert the video/audio/ancillary data into the desired formats, using the requisite codecs. A variety of techniques for this can be found in U.S. Pat. Nos. 9,458,456 and 9,432,704 and US Patent Application Publication Nos. 2013-0117418 A1 and 2012-0265853-A1, the teachings of all of which are hereby incorporated by reference in their entireties for all purposes. The teachings hereof are not limited to any particular technique or to whether the transcoding is performed in a distributed platform rather than locally.

As shown in FIG. 1, video access units are sent to video transcoder 104a, audio access units are sent to audio transcoder 104b, and ancillary data access units are sent to data transcoder 104c. It should be noted that any of the streams may also be passed through from the muxer to the demultiplexer for remuxing, as indicated in block 104. The pass through may take the form of the demuxer 101 sending access units for a given elementary stream to the respective transcoder 104, which then passes it through to the muxer 108. Alternatively, the demuxer 101 (or one of its output buffers 102) can send a pass through access unit directly to the muxer 108. Alternatively, a hybrid approach can be used: the demuxer 101 can send marker access units directly to the muxer, but send other access units (i.e., ones that actually contain ancillary data, audio, or video, as the case may be) through the transcoders 104. Pass through may occur if the transcoding job specifies only changes to the video encoding parameters, for example. Note that transcoding is merely one function: generalizing, intermediate processes such as transcoder 104 can be thought of as intermediate processes that may perform any kind of processing on access units, or may provide a mere pass through function.

The muxer 108 is preceded by buffers 106a, 106b, 106c that receive the video, audio and ancillary data streams, respectively, from the transcoding resources 104 (or directly from the demultiplexer 101 and/or its output buffers 102). In implementation, the buffers 106 can be part of the muxer 108.

Preferably, the multiplexing algorithm waits for at least one access unit from each type of source to be present (108a). In this example, this means that it waits until one video access unit, one audio access unit, and one ancillary data access unit have been received. The marker access unit (which continuing the example above was inserted by the muxer 108 because the ancillary data stream was lagging by more than the threshold of 6 seconds and thus is “spurious”) is treated as the ancillary data access unit. In effect, the muxer 108 interprets the marker access unit as a substitute for the non-existent ancillary data access unit, and hence determines that it may proceed under its multiplexing algorithm. Subsequently, the muxer 108 discards the marker access unit, sorts the remaining access units according to their decode timestamp (108b), and then multiplexes them together in that order in the output container (108c) to provide the output multiplexed stream after transcoding (110).

Note that the multiplexer 108 has no concept of the delay required for transcoding the different elementary streams. A video encoder may be much slower than an audio encoder, both of which may be taking place on independent and unsynchronized hardware. Hence the reason for the muxer 108 to wait for at least one access unit of each elementary stream to arrive, in order to account for these different speeds. This also assumes that all encoding or pass-through sources output the frames in bitstream order, which is a typical requirement for encoders.

The demultiplexer's 101 insertion of the marker access unit addresses many potential problems at the muxer 108. If part of a particular elementary stream were missing for part of the presentation or alternatively has spuriously appearing data, then the multiplexer may potentially end up waiting for at least one access unit from that source to arrive. The buffering 106 on the muxer side helps account for small variations in the appearance of data between different elementary streams; however, large variations on the order of seconds or minutes would lead to extremely large buffering requirements. Furthermore, a large time gap between the appearance of access units may actually delay a muxer working on a live multimedia stream from outputting muxed access units.

Preferably the demuxer generates an access unit and designates it as a marker access unit by setting a flag or putting a code in a custom field that is used internal to the system. An example of how the marker access unit is designated is provided in the ‘Exemplary Source Code’ section provided later in this document. The marker access unit is marked as MIPT_EMPTY_PAYLOAD.

A marker access unit preferably has the format of an access unit for video, audio, ancillary data access unit, or other type of access unit, so that it can be recognized and handled normally by components in the system 100. However, preferably the access unit does not contain any actual media data (i.e., image data, audio data, etc.). Preferably the marker access unit contains a code or identifier in a particular field to indicate to the muxer that it is a marker access unit. The marker access unit may contain timestamps just as other access units do. The teachings hereof are not limited to any particular content or format for the marker access unit, as long as the muxer can recognize and identify the marker access unit so as to be able to perform the techniques described herein.

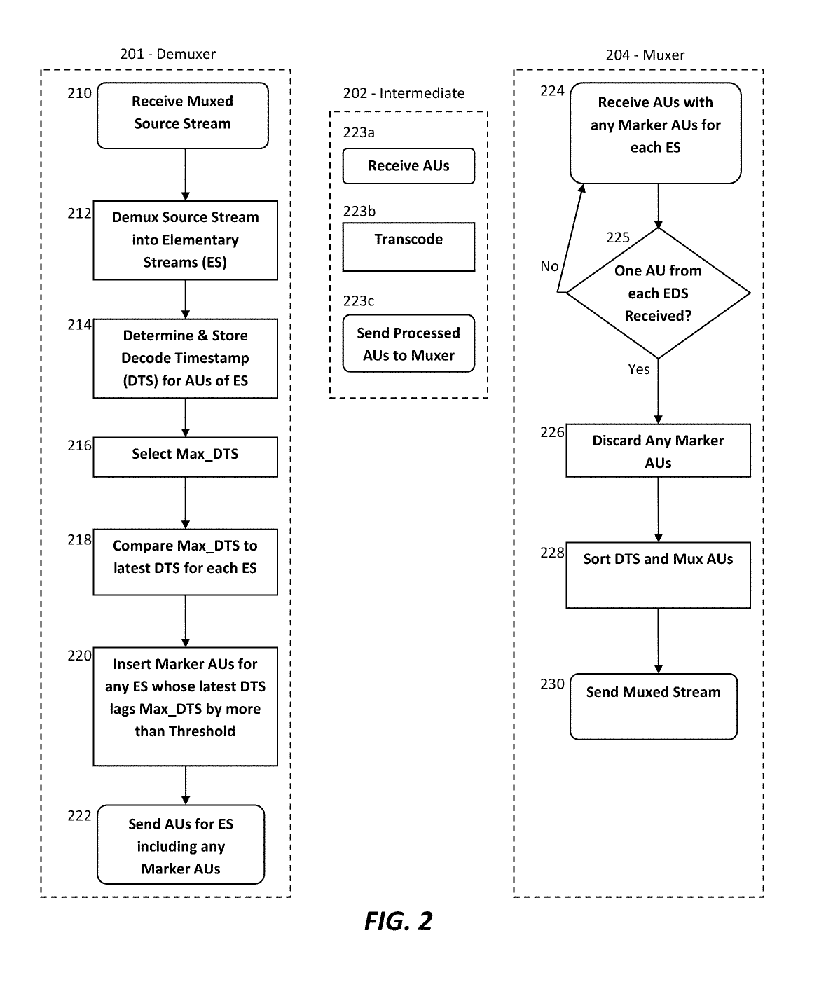

FIG. 2 is a flow chart illustrating the logical steps in an algorithm running in the transcoding system, in one embodiment. Note that in FIG. 2 and elsewhere herein the acronym ‘AU’ is used for ‘access unit’. The dotted lines denote the demuxer 201, intermediate processors (e.g., transcoders) 202, and muxer 204; however, the allocation of functions to particular processes or modules is merely exemplary and can be modified.

At steps 210 and 212, the demuxer receives the multiplexed source stream and demuxes it into elementary streams. Assume for explanatory purposes that the container carries three elementary streams, one for each of video, audio, and ancillary data. Known methods for demultiplexing can be used and implemented in accordance with container format standards (such as MPEG ISO based media file format or MPEG Transport Stream); examples of well known software packages that can be used for demultiplexing include Main Concept, FFMpeg, QuickTime 7 Player or Quicktime Pro, and Sorenson Squeeze.

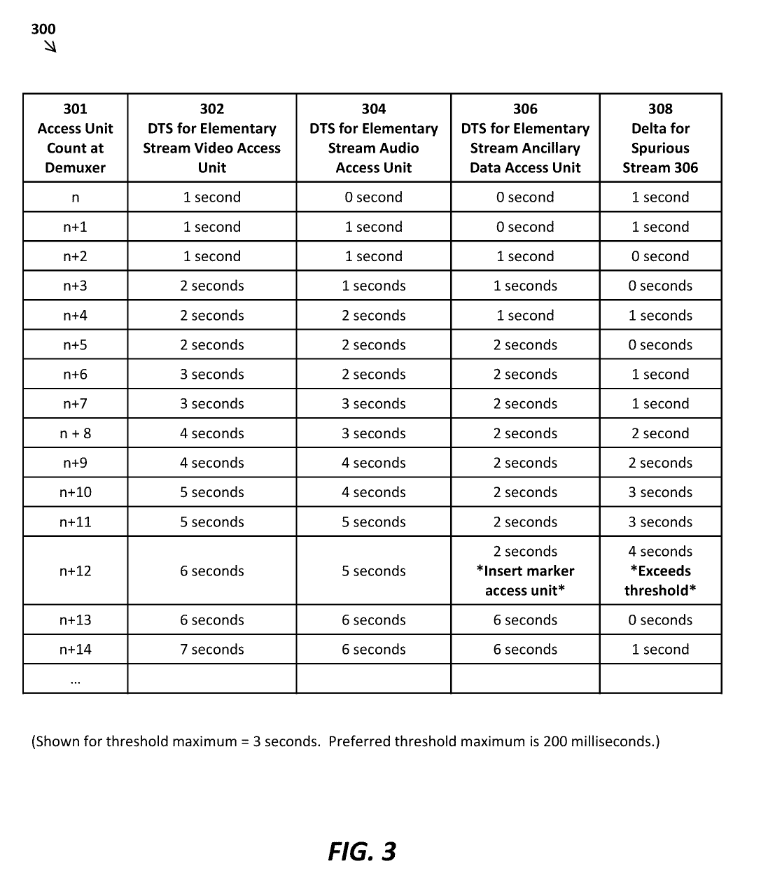

At step 214, the decode timestamp (DTS) from each arriving access unit of an elementary stream (after demuxing) is saved as an entry for that particular elementary stream. An example of a memory array for storing such information is provided in FIG. 3, which is described in further detail below. The entries are timestamps that indicate for each stream, in effect, the latest decode timestamp seen, which is typically the maximum numerical timestamp. (Note that in other embodiments, other type of timestamps could be used, including for example presentation timestamps (PTS).)

At step 216, the largest decode timestamp (DTS) is selected amongst all of the decode timestamps (Max DTS), comparing across elementary streams. Thus the DTS for video, the DTS for audio, and the DTS for ancillary data are compared to find the maximum DTS across elementary streams.

At step 218, the latest decode timestamp for each individual elementary stream is compared with the Max DTS value, and those streams which are behind this time by larger than some configurable, predetermined threshold value (for example, 200 milliseconds) will be marked for special processing. These are the spurious stream(s). The threshold value can vary depending on the implementation. It can be, in some embodiments, between about 50 milliseconds and about 5 seconds.

At step 222, the demuxer sends the access units for the elementary streams to the downstream transcoder for the corresponding access unit type (i.e. video access unit goes to video transcoder, audio access unit goes to audio transcoder, and so on), or to pass through components. The muxer sends any marker access units, which are marked for special processing, to the downstream transcoder or passthrough components as well. These were inserted at 220. The decode timestamp of the marker access unit is set to Max DTS. Also, the demuxer sets the decode timestamp being tracked for the spurious stream(s) that required the marker access unit to be the same as Max DTS.

If the intermediate processing 202 in the system is transcoding, which is what is shown in FIG. 2, then preferably any marker access unit is sent through the system unprocessed along with compressed access units in the same order, all the way to the output of the encoder. In case of pass-through, which is not shown in FIG. 2, preferably the marker access unit is passed through from input to output. As mentioned above, preferably the marker access unit can include an identifier or code that will signify to the muxer that this is a marker access unit and not an access unit holding data for one of the elementary streams.

At steps 223a-c, the elementary stream access units go to the transcoder (and/or passthrough, not shown), are transcoded if required, and then are sent to the muxer 204. The teachings hereof are agnostic as to a particular transcoding technique or algorithm. Any known technique can be used. Examples of a known software package that can be used for transcoding include Main Concept, FFMpeg, QuickTime 7 Player or Quicktime Pro, and Sorenson Squeeze.

At steps 224-225, when the muxer 204 receives the marker access unit and at least one access unit from every outgoing stream has been received, the timestamps are sorted and the access units are multiplexed into a target container format 228. The marker access unit(s) is discarded (226) prior to muxing. Then, the muxer 108 waits for the arrival of a new set of access units from each input source. The muxer can treat the marker access unit as an access unit for video, audio or ancillary data (whatever type the demuxer inserted the marker access unit for, as determined by the marker's its internal code/identifier and/or the buffer it resides in). While the muxer treats the marker access unit as an access unit for video, audio or ancillary data for purposes of steps 224-225, then the muxer discards the marker access unit before 228.

Examples of known software packages that can be used for multiplexing include Main Concept, FFMpeg, QuickTime 7 Player or Quicktime Pro, and Sorenson Squeeze.

At step 230, the system outputs the re-muxed, processed, output stream.

This approach presents a means of ensuring that the muxer waits for at least one access unit from an input source, while subsequently discarding marker access units. The operation of the muxer in the presence of spurious sources and normally occurring sources would remain the same, with the exception of the discarding of marker access units.

While often audio and/or ancillary data is a spuriously occurring source, the solution described here is agnostic to which source(s) elementary stream appears spuriously.

FIG. 3 is a table 300 illustrating how the demuxer 201 tracks the decode timestamps of arriving elementary streams. This is blocks 214, 216, 218 in FIG. 2. The values in FIG. 3 are merely exemplary and selected for illustrative purposes. Each row of the table 300 shows the contents of memory storing decode timestamps for each of the three elementary streams at particular access unit counts. Access units (also referred to as AUs or packets) are received at the demuxer. Column 301 shows the count of access units as they are received. The rows thus show the status of a memory location as access units ‘n’ through ‘n+14’ are processed and the memory locations updated. Column 302 corresponds to a memory location for decode timestamps of video data access units received at the demultiplexer; column 304 corresponds to memory location for decode timestamps of received audio data access units, and column 306 corresponds to a memory location for decode timestamps of received ancillary data access units.

Assume, merely for illustrative purposes, that the demuxer is configured with a threshold of 3 seconds to test for spurious streams. Assume further that the demultiplexer demuxes from the multiplexed stream a given access unit ‘n’ (as shown in column 301), and this access unit is a video access unit. Assume further that the decode timestamp (DTS) of this access unit is 1 second. Accordingly, the demuxer stores this timestamp value in location 302. The timestamp values for the audio and data streams in 304, 306 are not updated at this point. The delta 308 for the ancillary data stream access unit is 0 seconds. (Note that in this example only the delta for the ancillary data stream 308 is shown; one of ordinary skill in the art would understand that the delta for the audio or any other elementary streams could be calculated too, i.e., video delta would be 0 and audio would be 1 second.)

Moving to the next row, the demuxer then receives an access unit at count ‘n+1’. The demuxer determines it is an audio access unit with a DTS value of 1 second, so the demuxer updates location 304 to 1 second. The delta 308 for the data elementary stream is still 1 second.

The demuxer then receives an access unit at count ‘n+2’. The demuxer determines it is an ancillary data access unit with a DTS value of 1 second, so the demuxer updates location 306 to 1 second. The delta 308 for the ancillary data elementary stream is now 0 seconds.

Assume that the pattern repeats, with the demuxer receiving a video access unit ‘n+3’ with DTS=2 seconds, then an audio access unit ‘n+4’ with DTS=2 seconds, then an ancillary data access unit ‘n+5’ with DTS=2 seconds. The demuxer updates the locations 302, 304, 306, respectively, with these DTS values as each access unit is processed, calculating the delta 308 at each point.

Next, the demuxer receives a video access unit ‘n+6’ with DTS=3 seconds, and updates location 302. Then an audio access unit ‘n+7’ with DTS=3 seconds, and an update to location 304. At count ‘n+8’, the demuxer receives not an ancillary data access unit but a video access unit with DTS=4 seconds. The demuxer updates location 302. The delta 308 is now 2 seconds. Note that the delta 308 is calculated with respect to the difference between the largest DTS, in this case the video DTS of 4 seconds, and the ancillary data stream's last DTS of 2 seconds. (Also note again that only the delta for the ancillary data is shown in FIG. 3, but the delta for the audio stream would now be 1 second.)

Next, at count ‘n+9’, the demuxer receives an audio access unit with DTS=4 seconds and updates location 304.

At count ‘n+10’, the demuxer receives a video access unit with DTS=5 seconds and updates location 302. The delta 308 is now 3 seconds.

At count ‘n+11’, the demuxer receives an audio access unit with DTS=5 seconds and updates location 304.

Next, at count ‘n+12’, the demuxer receives a video access unit with DTS=6 seconds and updates location 302. The delta 308 is now 4 seconds, which exceeds the threshold of 3 seconds. Upon comparison, the demuxer recognizes that the threshold has been exceeded and therefore inserts a marker access unit into the flow of ancillary data access units, with DTS=6 seconds, the current maximum DTS value. It then updates column 306 to DTS=6 seconds.

As a result, when the demuxer receives the next access unit, at count ‘n+13’, the delta 308 is zero. The access unit ‘n+13’ is determined to be an audio access unit with DTS=6 seconds, so the demuxer updates location 304.

Finally, at count ‘n+14’, the demuxer receives a video access unit with DTS=7 seconds, and so updates location 302. The delta 308 becomes 1 second. The process continues.

Note that the buffer size needed at the input to the muxer can be determined by the threshold value, i.e., in the example shown in FIG. 3, at least three seconds worth of buffering is needed.

The operation of the demuxer 101, 201 can be further illustrated with reference to the following code, with comments inline to elucidate function. In this code, the term packet is used to refer to an access unit; the term flow is used to refer to a flow of access units in an elementary stream.

Exemplary Source Code

#define MIPT_PAYLOAD 0x00 /* Payload data */
#define MIPT_SEQINFO 0x01 /* Video sequence information */
#define MIPT_PICINFO 0x02 /* Picture information */
#define MIPT_VEXTRA 0x03 /* AVCodecContext .extradata for video */
#define MIPT_VNXTPTS 0x04 /* Lowest PTS in next streamlet */
#define MIPT_AEXTRA 0x11 /* AVCodecContext .extradata for audio */
#define MIPT_DEXTRA 0x12 /* AVCodecContext .extradata for data */
#define MIPT_TIMESTAMPS 0x20 /* Frame timestamps */
#define MIPT_DROPFRAME 0x21 /* Drop frame notice for end of GOP */
#define MIPT_EMPTYSLET 0x22 /* signal an expected empty streamlet */
#define MIPT_DTVCC_TIMESTAMPS 0x23 /* TIMESTAMP for DTVCC MIP */
#define MIPT_DTVCC 0x24 /*DTVCC */
#define MIPT_IDRFRAME 0x25 /*Force first frame encoded after this time to be IDR frame*/
#define MIPT_AD_INSERTION 0x26 /*AD Insertion point*/
#define MIPT_EMPTY_PAYLOAD 0x27 /*empty payload with timestamp */
#if 1

// 1) Save the last packet's decode timestamp
// 2) Search all saved timestamps and find the largest DTS value
// 3) Go through all flows, and if any are below the current max DTS,
// send an empty packet

// Save the latest packets's DTS time for the current stream (designated by m_flow)

m_pktTime[m_flow] = m_dtsSeconds;
float maxPktDTS = DBL_MIN; // initialize to smallest possible value
float maxPktCount = INT_MIN; // initialize to smallest possible value

// Determine the largest packet number for any input stream (m_fno array containing frame
numbers per flow) and DTS timestamps // (m _pktTime)

for(int iflow = 0; iflow < getNFlows( ); iflow++){

if(m_pktTime[iflow] > maxPktDTS)

maxPktDTS = m_pktTime[iflow];

if(m_fno[iflow] > maxPktCount)

maxPktCount = m_fno[iflow];

}

// For each input flow, perform the test:
// 1) Current packet is greater than 0.200 ms, and
// 2) This is not a video packet (e.g. it's either audio or data)
// 3) And we have seen at least 20 frames go by from all of the flows (in order to avoid issues
// where timestamps don't start from zero)
// If all tests pass, use the current packet's PTS or DTS for the empty packet, and set im_pktTime
// (timestamp save array) to the maximum DTS timestamp

for(int iflow = 0; iflow < getNFlows( ); iflow++){

if(

((maxPktDTS − m_pktTime[iflow]) >

MAXIMUM_SPURIOUS_PACKET_DELTA_TIME) && // if latest packet is farther ahead
than expected

!IsVideo(getInType(iflow)) && // and for audio and data packets only
(maxPktCount − m_fno[iflow] > 20)
) {
m_slFlow = iflow; // set internal streamlet number
Packet emptyPkt;

init_packet(&emptyPkt);

emptyPkt.pts = m _pkt.pts; //current packet
emptyPkt.dts = m_pkt.dts;
emptyPkt.size = 0;
emptyPkt.stream_index = getStreamIndex(m_slFlow);
passthruDemux(&emptyPkt, TYPE_EMPTY_PAYLOAD);
m_pktTime[m_slFlow] = maxPktDTS; //set flow to current DTS value
log(“Generating EMPTY PACKET for flow %d (%s) at time %2.2f (DTS %d)\n”,

m_slFlow, dataTypeString(m_slFlow), m_pktTime[m_slFlow], m_pkt.dts);

}

}

#endif

Computer Based Implementation

The client devices, servers, and other devices described herein may be implemented with conventional computer systems, as modified by the teachings hereof, with the functional characteristics described above realized in special-purpose hardware, general-purpose hardware configured by software stored therein for special purposes, or a combination thereof.

Software may include one or several discrete programs. Any given function may comprise part of any given module, process, execution thread, or other such programming construct. Generalizing, each function described above may be implemented as computer code, namely, as a set of computer instructions, executable in one or more microprocessors to provide a special purpose machine. The code may be executed using an apparatus—such as a microprocessor in a computer, digital data processing device, or other computing apparatus—as modified by the teachings hereof. In one embodiment, such software may be implemented in a programming language that runs in conjunction with a proxy on a standard Intel hardware platform running an operating system such as Linux. The functionality may be built into the proxy code, or it may be executed as an adjunct to that code, such as the “interpreter” referenced above.

While in some cases above a particular order of operations performed by certain embodiments is set forth, it should be understood that such order is exemplary and that they may be performed in a different order, combined, or the like. Moreover, some of the functions may be combined or shared in given instructions, program sequences, code portions, and the like. References in the specification to a given embodiment indicate that the embodiment described may include a particular feature, structure, or characteristic, but every embodiment may not necessarily include the particular feature, structure, or characteristic.

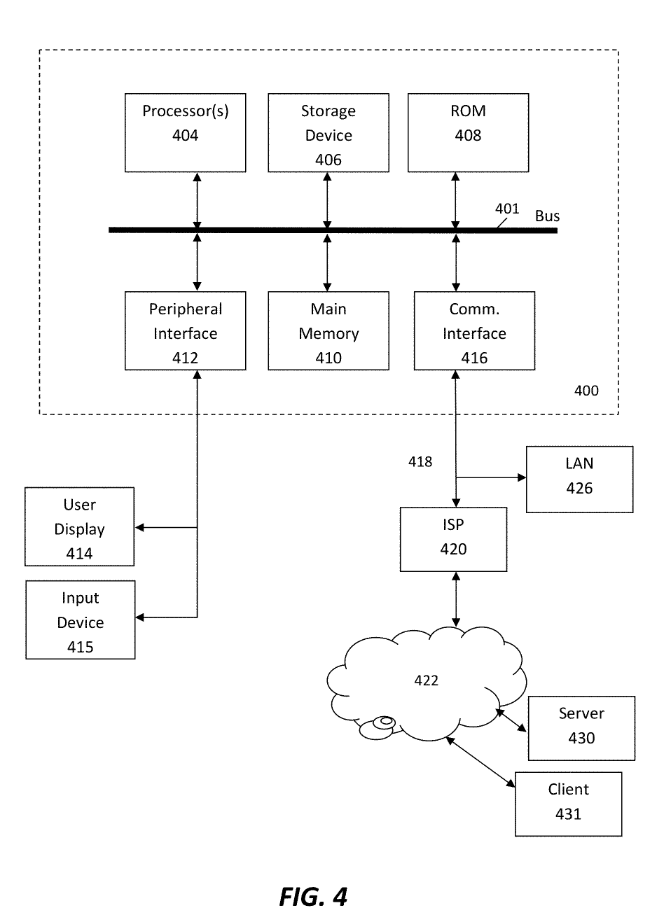

FIG. 4 is a block diagram that illustrates hardware in a computer system 400 upon which such software may run in order to implement embodiments of the invention. The computer system 400 may be embodied in a client device, server, personal computer, workstation, tablet computer, mobile or wireless device such as a smartphone, network device, router, hub, gateway, or other device. Representative machines on which the subject matter herein is provided may be Intel Pentium-based computers running a Linux or Linux-variant operating system and one or more applications to carry out the described functionality.

Computer system 400 includes a microprocessor 404 coupled to bus 401. In some systems, multiple processor and/or processor cores may be employed. Computer system 400 further includes a main memory 410, such as a random access memory (RAM) or other storage device, coupled to the bus 401 for storing information and instructions to be executed by processor 404. A read only memory (ROM) 408 is coupled to the bus 401 for storing information and instructions for processor 404. A non-volatile storage device 406, such as a magnetic disk, solid state memory (e.g., flash memory), or optical disk, is provided and coupled to bus 401 for storing information and instructions. Other application-specific integrated circuits (ASICs), field programmable gate arrays (FPGAs) or circuitry may be included in the computer system 400 to perform functions described herein.

A peripheral interface 412 communicatively couples computer system 400 to a user display 414 that displays the output of software executing on the computer system, and an input device 415 (e.g., a keyboard, mouse, trackpad, touchscreen) that communicates user input and instructions to the computer system 400. The peripheral interface 412 may include interface circuitry, control and/or level-shifting logic for local buses such as RS-485, Universal Serial Bus (USB), IEEE 1394, or other communication links.

Computer system 400 is coupled to a communication interface 417 that provides a link (e.g., at a physical layer, data link layer, or otherwise) between the system bus 401 and an external communication link. The communication interface 416 provides a network link 418. The communication interface 416 may represent a Ethernet or other network interface card (NIC), a wireless interface, modem, an optical interface, or other kind of input/output interface.

Network link 418 provides data communication through one or more networks to other devices. Such devices include other computer systems that are part of a local area network (LAN) 426. Furthermore, the network link 418 provides a link, via an internet service provider (ISP) 420, to the Internet 422. In turn, the Internet 422 may provide a link to other computing systems such as a remote server 430 and/or a remote client 431. Network link 418 and such networks may transmit data using packet-switched, circuit-switched, or other data-transmission approaches.

In operation, the computer system 400 may implement the functionality described herein as a result of the processor executing code. Such code may be read from or stored on a non-transitory computer-readable medium, such as memory 410, ROM 408, or storage device 406. Other forms of non-transitory computer-readable media include disks, tapes, magnetic media, CD-ROMs, optical media, RAM, PROM, EPROM, and EEPROM. Any other non-transitory computer-readable medium may be employed. Executing code may also be read from network link 418 (e.g., following storage in an interface buffer, local memory, or other circuitry).

Content Delivery Networks

The teachings hereof may be realized in a distributed computer systems such as a content delivery network or “CDN”, which is known in the art. One such type of “CDN” is operated and managed by a service provider (others are managed by the content provider themselves). The service provider typically provides the content delivery service on behalf of third parties. A “distributed system” of this type typically refers to a collection of autonomous computers linked by a network or networks, together with the software, systems, protocols and techniques designed to facilitate various services, such as content delivery or the support of outsourced site infrastructure. This infrastructure is shared by multiple tenants, typically content providers. The infrastructure is generally used for the storage, caching, or transmission of content—such as web pages, streaming media and applications—on behalf of such content providers or other tenants. The platform may also provide ancillary technologies used therewith including, without limitation, DNS query handling, provisioning, data monitoring and reporting, content targeting, personalization, and business intelligence. The CDN processes may be located at nodes that are publicly-routable on the Internet, within or adjacent nodes that are located in mobile networks, in or adjacent enterprise-based private networks, or in any combination thereof.

In a known system such as that shown in FIG. 1, a distributed computer system 100 is configured as a content delivery network (CDN) and is assumed to have a set of machines 102 distributed around the Internet. Typically, most of the machines are configured as servers and located near the edge of the Internet, i.e., at or adjacent end user access networks. A network operations command center (NOCC) 104 may be used to administer and manage operations of the various machines in the system. Third party sites affiliated with content providers, such as web site 106, offload delivery of content (e.g., HTML or other markup language files, embedded page objects, streaming media, software downloads, and the like) to the distributed computer system 100 and, in particular, to the servers (which are sometimes referred to as content servers, or sometimes as “edge” servers in light of the possibility that they are near an “edge” of the Internet). Such servers may be grouped together into a point of presence (POP) 107.

Typically, content providers offload their content delivery by aliasing (e.g., by a DNS CNAME) given content provider domains or sub-domains to domains that are managed by the service provider's authoritative domain name service. End user client machines 122 that desire such content may be directed to the distributed computer system to obtain that content more reliably and efficiently. The CDN servers respond to the client requests, for example by obtaining requested content from a local cache, from another CDN server, from the origin server 106, or other source.

Although not shown in detail in FIG. 1, the distributed computer system may also include other infrastructure, such as a distributed data collection system 108 that collects usage and other data from the CDN servers, aggregates that data across a region or set of regions, and passes that data to other back-end systems 110, 112, 114 and 116 to facilitate monitoring, logging, alerts, billing, management and other operational and administrative functions. Distributed network agents 118 monitor the network as well as the server loads and provide network, traffic and load data to a DNS query handling mechanism 115, which is authoritative for content domains being managed by the CDN. A distributed data transport mechanism 120 may be used to distribute control information (e.g., metadata to manage content, to facilitate load balancing, and the like) to the CDN servers.

As illustrated in FIG. 2, a given machine 200 in the CDN comprises commodity hardware (e.g., a microprocessor) 202 running an operating system kernel (such as Linux® or variant) 204 that supports one or more applications 206a-n. To facilitate content delivery services, for example, given machines typically run a set of applications, such as an HTTP proxy 207, a name server 208, a local monitoring process 210, a distributed data collection process 212, and the like. The HTTP proxy 207 (sometimes referred to herein as a global host or “ghost”) typically includes a manager process for managing a cache and delivery of content from the machine. For streaming media, the machine typically includes one or more media servers, such as a Windows® Media Server (WMS) or Flash server, as required by the supported media formats.

A given CDN server shown in FIG. 2 may be configured to provide one or more extended content delivery features, preferably on a domain-specific, content-provider-specific basis, preferably using configuration files that are distributed to the CDN servers using a configuration system. A given configuration file preferably is XML-based and includes a set of content handling rules and directives that facilitate one or more advanced content handling features. The configuration file may be delivered to the CDN server via the data transport mechanism. U.S. Pat. No. 7,240,100, the contents of which are hereby incorporated by reference, describe a useful infrastructure for delivering and managing CDN server content control information and this and other control information (sometimes referred to as “metadata”) can be provisioned by the CDN service provider itself, or (via an extranet or the like) the content provider customer who operates the origin server. U.S. Pat. No. 7,111,057, incorporated herein by reference, describes an architecture for purging content from the CDN.

In a typical operation, a content provider identifies a content provider domain or sub-domain that it desires to have served by the CDN. The CDN service provider associates (e.g., via a canonical name, or CNAME, or other aliasing technique) the content provider domain with a CDN hostname, and the CDN provider then provides that CDN hostname to the content provider. When a DNS query to the content provider domain or sub-domain is received at the content provider's domain name servers, those servers respond by returning the CDN hostname. That network hostname points to the CDN, and that hostname is then resolved through the CDN name service. To that end, the CDN name service returns one or more IP addresses. The requesting client application (e.g., browser) then makes a content request (e.g., via HTTP or HTTPS) to a CDN server associated with the IP address. The request includes a host header that includes the original content provider domain or sub-domain. Upon receipt of the request with the host header, the CDN server checks its configuration file to determine whether the content domain or sub-domain requested is actually being handled by the CDN. If so, the CDN server applies its content handling rules and directives for that domain or sub-domain as specified in the configuration. These content handling rules and directives may be located within an XML-based “metadata” configuration file, as described previously. Thus, the domain name or subdomain name in the request is bound to a particular configuration file, which contains the rules, settings, etc., that the CDN server should use for that request.

As an overlay, the CDN resources may be used to facilitate wide area network (WAN) acceleration services between enterprise data centers (which may be privately managed) and to/from third party software-as-a-service (SaaS) providers.

CDN customers may subscribe to a “behind the firewall” managed service product to accelerate Intranet web applications that are hosted behind the customer's enterprise firewall, as well as to accelerate web applications that bridge between their users behind the firewall to an application hosted in the internet cloud (e.g., from a SaaS provider). To accomplish these two use cases, CDN software may execute on machines (potentially in virtual machines running on customer hardware) hosted in one or more customer data centers, and on machines hosted in remote “branch offices.” The CDN software executing in the customer data center typically provides service configuration, service management, service reporting, remote management access, customer SSL certificate management, as well as other functions for configured web applications. The software executing in the branch offices provides last mile web acceleration for users located there. The CDN itself typically provides CDN hardware hosted in CDN data centers to provide a gateway between the nodes running behind the customer firewall and the CDN service provider's other infrastructure (e.g., network and operations facilities). This type of managed solution provides an enterprise with the opportunity to take advantage of CDN technologies with respect to their company's intranet, providing a wide-area-network optimization solution. This kind of solution extends acceleration for the enterprise to applications served anywhere on the Internet. By bridging an enterprise's CDN-based private overlay network with the existing CDN public internet overlay network, an end user at a remote branch office obtains an accelerated application end-to-end. FIG. 3 illustrates a general architecture for a WAN, optimized, “behind-the-firewall” service offerings described above.

The CDN may have a variety of other features and adjunct components. For example the CDN may include a network storage subsystem (sometimes referred to herein as “NetStorage”) which may be located in a network datacenter accessible to the CDN servers, such as described in U.S. Pat. No. 7,472,178, the disclosure of which is incorporated herein by reference. The CDN may operate a server cache hierarchy to provide intermediate caching of customer content; one such cache hierarchy subsystem is described in U.S. Pat. No. 7,376,716, the disclosure of which is incorporated herein by reference. Communications between CDN servers and/or across the overlay may be enhanced or improved using techniques such as described in U.S. Pat. Nos. 6,820,133, 7,274,658, 7,660,296, the disclosures of which are incorporated herein by reference.

For live streaming delivery, the CDN may include a live delivery subsystem, such as described in U.S. Pat. No. 7,296,082, and U.S. Publication No. 2011/0173345, the disclosures of which are incorporated herein by reference.

It should be understood that the foregoing has presented certain embodiments of the invention that should not be construed as limiting. For example, certain language, syntax, and instructions have been presented above for illustrative purposes, and they should not be construed as limiting. It is contemplated that those skilled in the art will recognize other possible implementations in view of this disclosure and in accordance with its scope and spirit. The appended claims define the subject matter for which protection is sought.

It is noted that trademarks appearing herein are the property of their respective owners and used for identification and descriptive purposes only, given the nature of the subject matter at issue, and not to imply endorsement or affiliation in any way.

1. A method performed by a transcoding system that comprises a demultiplexer process, a plurality of transcoder processes that include a first and second transcoder processes, and a multiplexer process, each process hosted in at least one of one or more computers in the transcoding system, the method comprising:
with the demultiplexer process:
receiving a multimedia stream comprising a plurality of multiplexed elementary streams, the plurality of elementary streams each having a type and each having a plurality of access units of that type, including a first elementary stream of a first type and a second elementary stream of a second type, wherein the first and the second types are different from one another and the first and second types are each selected from the group of types consisting of: video, audio, ancillary data;
demultiplexing a first portion of the multimedia stream to obtain a first access unit that has a first type and a second access unit that has a second type;
determining a first timestamp for the first access unit and a second timestamp for the second access unit;
setting the first timestamp as a maximum timestamp associated with the first type and the second timestamp as a maximum timestamp associated with the second type, wherein the maximum timestamp associated with the first type and the maximum timestamp associated with the second type are each stored in memory;
sending the first access unit to a first transcoder process, and the second access unit to any of: a second transcoder process and the multiplexer process;
demultiplexing a second portion of the multimedia stream to obtain a third access unit that has the first type;
determining a third timestamp for the third access unit;
sending the third access unit to the first transcoding process, and setting the third timestamp as the maximum timestamp associated with the first type;
comparing the maximum timestamp associated with the first type, which is equal to the third timestamp, to the maximum timestamp associated with the second type, which is equal to the second timestamp;
based at least in part on upon a determination that the maximum timestamp associated with the first type, which is equal to the third timestamp, exceeds the maximum timestamp associated with the second type, which is equal to the second timestamp, by a predetermined threshold value:
generating and sending a marker access unit to at least one of: (i) the multiplexer process, and (ii) the second transcoder process, for subsequent transmission to the multiplexer process.

2. The method of claim 1, further comprising: with the first and second transcoder processes, receiving at least the first, second, and third access units, and sending the first, second, and third access units to the multiplexer process.

3. The method of claim 1, wherein the marker access unit includes a code that enables the multiplexer process to distinguish the marker access unit from access units of the video type, audio type, and ancillary data type.

4. The method of claim 1, further comprising:
with the multiplexer process:
monitoring a plurality of buffers associated with the multiplexer process, the plurality of buffers including at least one buffer associated with each of the plurality of elementary streams, wherein the at least one buffer for a given elementary stream receives access units of a type corresponding to the given elementary stream, wherein the plurality of buffers includes a first buffer associated with the first type and a second buffer associated with the second type;
monitoring the plurality of buffers to determine when the multiplexer process has received at least one access unit for each of the plurality of elementary streams;
determining when the multiplexer process has received at least one access unit for each of plurality of elementary streams, wherein said determination comprises the multiplexer process treating the marker access unit as the at least one access unit of the second type, and upon said determination:
(iii) discarding the marker access unit;
(iv) performing a multiplexing operation on the access units received in the plurality of buffers for each of the plurality of elementary streams, other than that of the second type.

5. The method of claim 1, further comprising:
based at least in part on upon the determination that the third timestamp exceeds the stored second timestamp by a predetermined value: setting the third timestamp as the maximum timestamp associated with the second type.

6. The method of claim 1, wherein the plurality of transcoding processes are hosted in a plurality of distributed computers distinct from one another and from the host of the multiplexer process and the host of the demultiplexer process, to form a distributed transcoding system.

7. The method of claim 1, wherein the plurality of elementary streams comprises three or more elementary streams.

8. The method of claim 1, wherein the plurality of elementary streams comprises three elementary streams, the first elementary stream being any of a video stream and an audio stream, the second elementary stream being any of an audio stream and an ancillary data stream, and the third elementary stream being any of a video stream and an audio stream.

9. The method of claim 1, wherein the plurality of elementary streams comprises more than three elementary streams, with one of the elementary streams being of a video type, and each of the remaining elementary streams being any of: audio type and ancillary data type.

10. The method of claim 1, wherein the first, second, and third timestamps comprise decode timestamps.

11. A method performed by a transcoding system the comprises a demultiplexer process, a plurality of intermediate processes, and a multiplexer process, each process hosted in one or more computers in the transcoding system, the method comprising:
A. with the demultiplexer process:
receiving a multimedia stream comprising a plurality of multiplexed elementary streams each having a plurality of access units, each of the plurality of elementary streams and access units thereof being of a type, the type selected from the group of types consisting of: video, audio, ancillary data;
demultiplexing the plurality of multiplexed elementary streams to obtain access units for the plurality of elementary streams;
determining timestamps for each of the obtained access units of the plurality of elementary streams;
maintaining a maximum timestamp value, independently, for each of the plurality of elementary streams, at least by: upon demultiplexing a given access unit of the given elementary stream type from the multimedia stream, updating a maximum timestamp value for a given elementary stream type with the timestamp value extracted from the given access unit;
sending each obtained access unit of a given elementary stream type to any of: the multiplexer process, and an intermediate process in the plurality of intermediate processes;
comparing the maximum timestamp values maintained for each of the plurality of elementary streams;
upon a determination that the maximum timestamp value for a first elementary stream exceeds the maximum timestamp value for a second elementary stream, at least by a predetermined value, generating and sending a marker access unit to any of: (i) the multiplexer process, and (ii) one of the one or more intermediate processes that is of the second elementary stream type;
B. with each of the plurality of intermediate processes:
receiving access units of a given elementary stream from the demultiplexer process, and processing said access units to create processed access units of the given elementary stream;
wherein said processing comprises any of (i) transcoding and (ii) passthrough;
sending processed access units of the given elementary stream to the multiplexer process;
C. with the multiplexer process:
receiving access units from any of: (i) the demultiplexer process, and (ii) the plurality of intermediate processes;
buffering the received access units in a plurality of buffers, wherein said buffering comprises buffering access units of a given elementary stream in a buffer corresponding to the given elementary stream;
monitoring the plurality of buffers to determine when the multiplexer process has received at least one access unit associated with every one of the plurality of elementary streams, where the multiplexer process treats the marker access unit as the access unit associated with the second elementary stream;
upon said determination, discarding the marker access unit, and performing a multiplexing operation on access units received in the plurality of buffers for each the plurality of elementary streams other than the second elementary stream.

12. The method of claim 11, wherein the plurality of intermediate processes comprise any of (i) pass-through processes and (ii) transcoder processes.

13. The method of claim 11, wherein the marker access unit includes a code that enables the multiplexer to distinguish the marker access unit from access units of the video type, audio type, and ancillary data type.

14. The method of claim 11, further comprising, upon the demultiplexer process sending the marker access unit, the demultiplexer process updating the maximum timestamp value for the second elementary stream to equal the timestamp value of the first elementary stream.

15. The method of claim 11, wherein the plurality of intermediate processes are hosted in a plurality of distributed computers distinct from one another and from the host of the multiplexer process and the host of the demultiplexer process, to form a distributed transcoding system.

16. The method of claim 11, wherein the plurality of elementary streams comprises three or more elementary streams.

17. The method of claim 11, wherein the plurality of elementary streams comprises three elementary streams, the first elementary stream being any of a video stream and an audio stream, the second elementary stream being any of an audio stream and an ancillary data stream, and the third elementary stream being any of a video stream and an audio stream.

18. The method of claim 11, wherein the plurality of elementary streams comprises more than three elementary streams, with one of the elementary streams being of a video type, and each of the remaining elementary streams being any of: audio type and ancillary data type.

19. The method of claim 11, wherein the timestamp values for access units comprise decode timestamps.
